(19) United States
(12) Patent Application Publication
(10) Pub. No.: US 2003/0040838 A1
(43) Pub. Date: Feb. 27, 2003

(54) High speed digital media vending system

(76) Inventors: Willie A. Lagunzad, San Jose, CA (US); Ian Bast, San Bruno, CA (US)

Correspondence Address: Intellectual Property Law Group LLP, 12 South First Street, 12th Floor, San Jose, CA, 95113, US

(21) Appl. No.: 09/939,322

(22) Filed: Aug. 24, 2001

(51) Int. Cl. G06F 17/00

(52) U.S. Cl. 700/232

(57) ABSTRACT

A digital media vending system for distribution of digital media content through the Internet using a broadband connection is disclosed, which allows quick and convenient media selection, retrieval and fast access to digital media contents for previewing or purchase by the users.

### BACKGROUND

The present invention relates to a digital media vending machine to distribute digital media content.

Digital media content is currently distributed through the Internet and at retail stores. The problem with obtaining the digital media content through the Internet is that downloading large files containing the digital media content can be extremely time consuming when one does not have access to a high speed broadband connection. Many Internet users are not willing to pay for the broadband Internet connection just to have convenient access to the digital media contents located on the Internet. Digital media contents can also be distributed through retail stores. However, selling digital media content at retail stores is not desirous because doing so would require shelf space, inventory maintenance, packaging, shipping and handling, all of which are added business cost.

Currently, vending machines that are used to copy purchased songs onto compact discs (CDs) exist.

For example, one existing vending system for distributing digitally encoded media to a compact disc provides an interface allowing users to select the information of choice to be recorded onto a CD.

This system has numerous shortcomings. First, a constant attention will be required to operate the vending machine because a supply of CDs (or other recordable media), CD sleeves, and ink must be maintained to print to CD sleeves and the CD surface.

Second, this system uses a modem which requires a dial up connection, which is limited in the bandwidth and rate of data transfer.

Third, this system lacks the ability to transfer digital media content directly to a target data storage device, such as an MP3 player or a laptop computer, rather than onto a data storage medium such as a CD.

Another example of existing vending systems is a compact disc selection and recording system for the automated merchandising of music entertainment of recordable CDs which uses a CD jukebox as the source of the digital media contents.

This system also has many shortcomings.

First, the available digital media content is restricted to the content of the CDs that will fit in the jukebox.

Second, the digital media content is restricted to songs and other audio content.

Third, adding new digital media content requires physical delivery and installation of new CDs into the jukebox.

Fourth, there is no convenient, centralized way to track users' purchase history of the digital media content for the purposes of paying royalties to owners of the copyright in the distributed digital media contents.

Fifth, the delivery of the digital media content is restricted to writing data to CDs.

Therefore, there is a need to provide a digital media vending system for distribution of digital media contents through the Internet using a high bandwidth broadband connection for quick and convenient media selection and retrieval by the user.

There is also a need to provide a digital media vending system which can distribute not only audio contents such as songs, but also other types of content such as video, text, movies, games, etc.

Further, there is a need to provide a digital media vending system that provides wide selection of digital media contents, and for which updating the content can be easily done.

Yet further desirous is a digital media vending system which allows transfer of digital media contents to not only recording media such as recordable CDs, but also directly to a user's digital media devices such as an MP3 player, haldheld computing device, and laptop portable computers. Such improved digital media vending system with direct transfer of digital media contents to the users' digital media devices will not require constant attention to maintain and operate the vending machine because no supply of parts such as blank CDs (or other recordable media), CD sleeves, or ink needs to be stocked in the vending machine for producing CDs containing desired digital media contents.

Still desirous is a digital media vending system that provides a convenient, centralized means to track users' purchase history of the digital media content for the purposes of paying royalties to owners of the copyright in the distributed digital media contents.

### SUMMARY

The present invention satisfies these needs.

The digital media vending system of the present invention is a computer networked digital media distribution system for distribution of digital media contents through the Internet using a high bandwidth broadband connection known as broadband connection, allowing quick and convenient media selection, retrieval, and fast access to digital media contents for purchase by the users. Instead of a CD jukebox, the present invention uses a centralized media server to hold the digital media contents. Delivery to local digital vending machines is achieved via broadband connection.

The digital media vending system of the present invention can distribute not only audio contents such as songs, but also other types of digital media contents such as video, text, movies, games, etc.

The digital media vending system of the present invention provides wide selection of digital media contents which are stored on a centralized media server located on the Internet, and updating the digital media contents can be easily done. Users of this digital media vending system are able to create a customized digital media content product out of available digital media contents.

The digital media vending system of the present invention allows transfer of digital media contents to not only recording media such as recordable CDs, but also directly to the user's digital media devices such as an MP3 player, haldheld computing device, and laptop portable computers. For instance, if the digital media content that a user seeks is an audio in digitally compressed format such as MP3 (which stands for MPEG audio layer 3), the digital media vending system of the present invention allows the user to connect a digital media device such as an MP3 player to the digital media device interface on the digital media vending machine of the present invention and download the digital media content directly to such digital media device.

This ability to directly transfer digital media contents to the user's digital media device is desirable because it significantly speeds up the purchase of such digital media contents (downloading is faster than burning a CD), saves the cost of producing the CDs, and provides a more reliable vending machine since no moving parts are involved such as CD burner, dispenser, or CD label printer.

The digital media vending system of the present invention provides a convenient, centralized means to track users' purchase history of the digital media contents for the purposes of paying royalties to owners of the copyright in the distributed digital media contents.

Sellers who distribute digital media contents may benefit from using the digital media vending system of the present invention as well. Using the digital media vending machine of the present invention, shelf space is no longer needed to distribute digital media contents such as music, books, maps, games, etc., to customers who wish to purchase such digital media contents. Inventory will not be limited to how much a store can physically carry, as the centralized media server of the present invention will hold the digital media contents. No packaging or shipping is involved to distribute the digital media contents to the customers, resulting in savings in business operation costs.

Where digital media contents are directly provided to the user's digital media device connected to the digital media vending machine of the present invention, maintaining and operating the digital media vending machine is easy and reliable because no supply of parts such as blank CDs (or other recordable media), CD sleeves, or ink needs to be constantly stocked in the vending machine.

The purchases are more easily tracked and recorded to a centralized media server via the Internet so that royalties can be properly paid out to recording companies, groups, or individuals owning copyright to distributed digital media contents.

In one embodiment, the digital media vending system of the present invention for providing digital media contents to a user, may comprise:

a) a centralized media server, which may be a group of multiple databases, connected to a computer network such as the Internet, said centralized media server containing the digital media contents or marketing information related to the digital media contents; and

b) a digital media vending machine comprising:

(i) an input device for allowing the user to select one or more desired digital media contents;

(ii) a digital media device interface for delivering desired digital media contents to the user;

(iii) a monitor for displaying video portions of the desired digital media contents;

(iv) an audio device for outputting audio portions of the desired digital media contents;

(v) a financial exchange device for executing financial payment transactions; and

(vi) a computer being communicably connected to the centralized media server via broadband connection for ordering the desired digital media contents and transferring the desired digital media contents from the centralized media server to the digital media device interface, said computer being adapted to send back royalty information related to the desired digital media contents purchased by the user to the centralized media server, such that appropriate royalty may be paid to one or more owners of royalty rights to the desired digital media contents, said computer having:

(1) a high capacity media storage device used to cache one or more recently or frequently accessed digital media contents; and

(2) a software which performs an analysis of the desired digital media contents and suggest additional digital media contents that may be of interest to the user.

### DRAWINGS

FIG. 1 is a perspective view of an embodiment of the digital media vending machine of the present invention.

FIG. 2 illustrates user interaction with the digital media vending machine of the present invention to retrieve desired digital media content from a centralized media server.

### DETAILED DESCRIPTION OF THE INVENTION

The following discussion describes in detail one embodiment of the invention and several variations of that embodiment. This discussion should not be construed, however, as limiting the invention to those particular embodiments. Practitioners skilled in the art will recognize numerous other embodiments as well. For a definition of the complete scope of the invention, the reader is directed to the appended claims.

The digital media vending system 1 of the present invention is a computer networked digital media distribution system designed to give users who do not have broadband Internet connection fast access to digital media content for purchase.

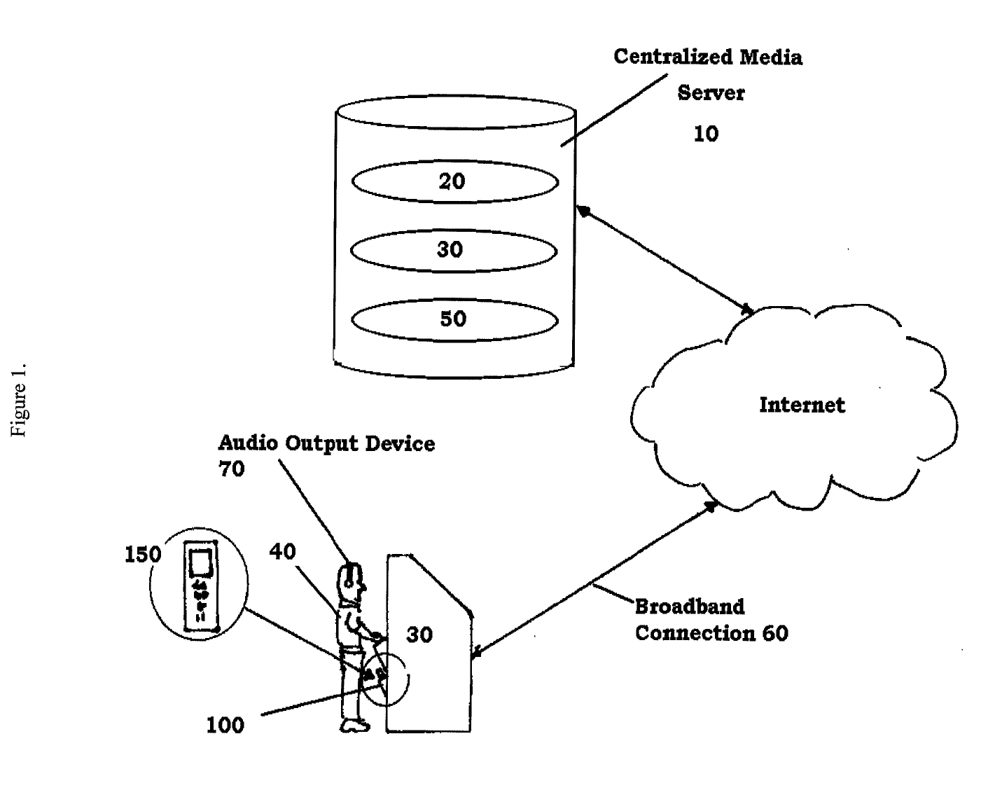

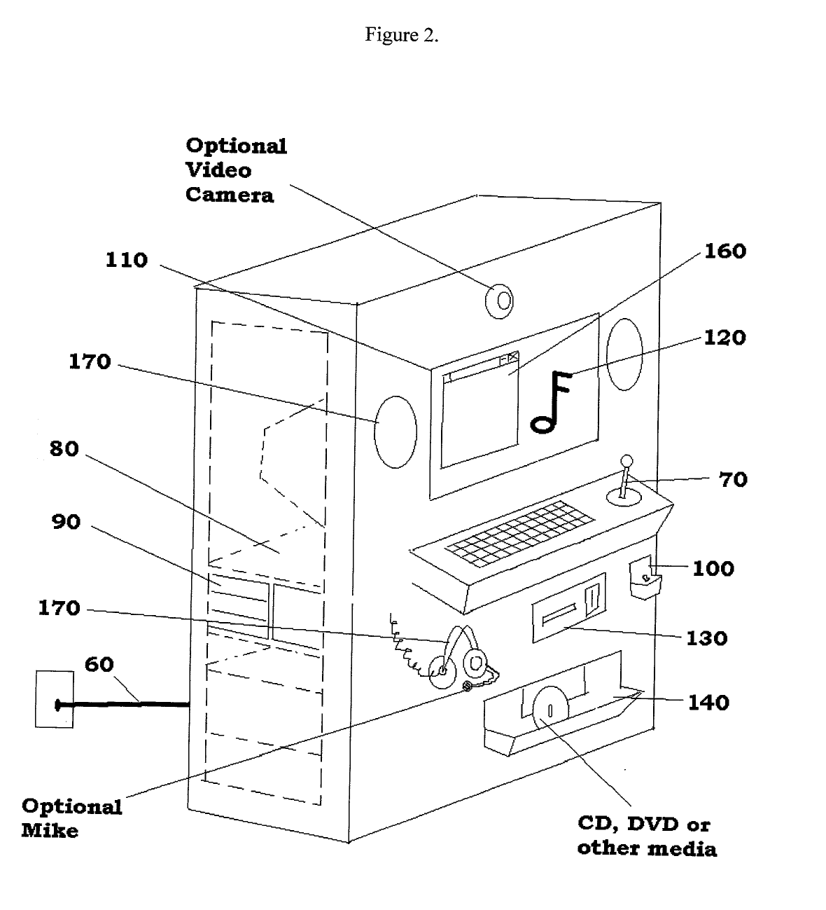

Referring to FIGS. 1 and 2, the digital media vending system 1 includes a centralized media server 10. The centralized media server 10 is a database or a network of databases located on the Internet containing a set of digital media contents 20 and marketing information 50 related to the digital media contents 20. There may be a database that holds only audio content, another that holds video content, another holding electronic books, etc. Physically, the databases may be housed in different locations in many networked machines. The entire collection of machines is referred to as the centralized media server 10. Instances of digital media contents 20 include, but are not limited to, digital music audio, digital video, video games, electronic maps, electronic books, audio books, digital photos, and electronic text. Along with the digital media contents 20, the centralized media server 10 will also contain meta-contents, i.e., information about the digital media contents 20 themselves. For instance, in the case of digital music, the meta-content can be the name of the performing artist or group, the name of the song, the name of the album containing the song, a list of songs appearing in the same album, a list of albums from the same artist, the genre of music the song belongs to, or the name of the record company which produced the album. The digital media contents 20 are delivered to users 40 through individual digital media vending machines 30 connected to the centralized media server 10, using broadband connection 60. The broadband connection 60 could be dedicated T1, T3, cable modem, digital subscriber line (DSL), satellite, or any other fast Internet connection. Using the broadband connection 60, the digital media vending system 1 will deliver all forms of digital media contents 20, not just music. The system 1 can update every digital media vending machine 30 with the latest contents instantaneously.

The digital media vending machine 30 allows users 40 to access and retrieve the digital media contents 20 stored in the centralized media server 10. Additional information about the digital media contents 20 will be available to assist users 40 with their selection of desired digital media contents 120 to be accessed and retrieved. This additional information was previously referred to as meta-content or information about the content itself. For instance, in the case where the digital media content is a song, the meta-content can be information about who wrote the song, who performed the song, the name of the records where the song appears, who produced the album, what genre the song belongs to, the date the song was released, etc. This meta-content will aid the user 40 in searching for digital media contents 20 to be purchased. For instance, the user 40 will be able to search for a song by title, by album, by genre, or by different combinations of fields contained in the meta-content. The digital media vending machine 30 includes an input device 70 for allowing the user 40 to select desired digital media contents 120, a computer 80 containing one or more high capacity media storage devices 90 used to cache recently or frequently accessed digital media contents 20, and a digital media device interface 100 for delivering the desired digital contents 120 to the user 40.

Use of the input device 70 may entail pressing keys on a keyboard or selecting items on the screen via touch screen or some other pointing device. The user 40 may be given a sampling of the digital media contents 20 of his selection. For instance, if the digital media content 20 the user 40 selected is a digital song, a short clip of the song may be played.

The computer 80 hosts software 160 necessary for user 40 to make selections of desired digital media contents 120 and deliver such desired digital media contents 120 to the user 40.

The digital media contents 20 may be cached locally on the high capacity media storage device 90. As new digital media contents 20 become available, the centralized media server 10 will upload such new digital media contents 20 to the digital media vending machines 30 via the broadband connection 60. The digital media vending system 1 can update every digital media vending machine 30 with the latest digital media contents 20 instantaneously.

The user 40 may put on an optional audio output device 170 such as a headset. In an alternative embodiment, the digital media vending machine 30 may operate as a digital media jukebox, where it will have external speakers or output jacks that will allow the attachment of speakers and the user 40 can elect to have the digital media contents be outputted in audio format through the speakers as he makes selections.

The user 40 will search the centralized media server 10 for the digital media contents 20 he is interested in, using menus and input boxes displayed on the monitor 110. The search can be made based on various criteria. For instance, if the desired digital media content 120 is digital music, the search can be made based on the song title, by artist name, or by musical genre.

The digital media vending machine 30 may include a monitor 110 for displaying video portions of desired digital media contents 120. The user 40 uses the web interface to search for digital media contents 20 of choice. The user 40 may preview his selections by seeing or hearing samples.

A list of digital media contents 20 that the user 40 selected will be maintained and can be viewed through the monitor 110. The user 40 will be able to view the list, add items, delete items, or rearrange items on the list, view the price for each item on the list, and see a total price for all items on the list. The software 160 may perform an analysis on the list and suggest additional items that may be of interest to the user 40.

In an embodiment of the invention, the digital media vending machine 30 will be in the form of a private booth, where user 40 can choose to experience the digital media in private. The digital media vending machine 30 will have external speakers or output jacks that will allow the attachment of speakers.

The user 40 pays for his purchase of desired digital media contents 120 by a payment method 130, which could be a credit card, debit card, or cash (like a soda machine). After the purchase payment by payment method 130 has been received and approved, the digital media vending machine 30 delivers the desired digital media contents 120 to the user 40.

In a preferred embodiment of the present invention, the digital media vending machine 30 downloads the desired digital media contents 120 directly to user 40's digital media device 150, wherein the digital media device 150 is communicably connected to the digital media vending machine 30 through the digital media device interface 100.

In another embodiment of the present invention, the digital media vending machine 30 includes a media writer 140 as the digital media device interface 100. This media writer 140 may be a compact disc recording device which burns a CD containing the desired digital media contents 120 for the user 40. Alternatively, this media writer 140 can also be in the form of a digital versatile disc (DVD) burner, or any other media recording/storage format.

For instance, if the desired digital media contents 120 are digital audio in MP3 format, the user 40 may choose to write the audio to a CD, or he can download the desired digital media contents 120 directly to the digital media device 150 such as an MP3 player device connected to the digital media vending machine 30 via digital media device interface 100, an example of which is a USB port. Other examples of digital media device 150 include, but are not limited to, a laptop computer, a handheld computing device, a cellular phone with Internet connectivity, etc. If the user 40 chooses to have the desired digital media contents 120 outputted to a CD, then the desired digital media contents 120 will be written to a CD and dispensed out through a CD receptacle (labeled in FIG. 2 as item 4).

In another embodiment, the present invention acts as an Internet phone using a standard Internet Protocol for public voice and image transmission. For example, the digital media vending machine 30 of the present invention may include an optional video camera to capture and transmit video images such that the user 40 may place a videophone call.

In one embodiment of the present invention, during the download process of the digital media contents 20, the monitor 110 of the digital media vending machine 30 will display marketing information 50 that might be of interest to the user 40 based on the desired digital media contents 120 he currently purchased.

Information about the purchase will be sent back to the centralized media server 10 for various purposes. For instance, in the case of digital music, a list of purchases will be maintained so that the appropriate royalty amount may be paid to the company or individual owning the rights to the songs.

What is claimed is:

1. A digital media vending system for providing digital media contents to a user, comprising:
a) a centralized media server connected to a computer network, said centralized media server containing a plurality of digital media contents or marketing information related to the digital media contents; and
b) a digital media vending machine comprising:
(i) an input device for allowing the user to select one or more desired digital media contents;
(ii) a digital media device interface for delivering the desired digital media contents to the user; and
(iii) a computer being communicably connected via broadband connection to the centralized media server for ordering the desired digital media contents for delivery from the centralized media server to the user via the digital media device interface, wherein said computer includes a high capacity media storage device used to cache one or more recently or frequently accessed digital media contents.

2. The digital media vending system of claim 1, wherein the digital media vending machine further comprises a monitor for displaying one or more video portions of the desired digital media contents.

3. The digital media vending system of claim 1, wherein the digital media vending machine further comprises an audio output device for allowing the user to listen to one or more audio portions of the desired digital media contents.

4. The digital media vending system of claim 1, wherein the digital media vending machine further comprises a financial exchange device for executing financial payment transactions.

5. The digital media vending system of claim 1, wherein the computer includes a software which performs an analysis of the desired digital media contents and suggest additional digital media contents that may be of interest to the user.

6. The digital media vending system of claim 5, wherein the computer is adapted to display marketing information on the monitor that might be of interest to the user based on the desired digital media contents.

7. The digital media vending system of claim 1, wherein the computer is adapted to send back royalty information related to the desired digital media contents purchased by the user to the centralized media server, such that appropriate royalty may be paid to one or more owners of royalty rights to the desired digital media contents.

8. A digital media vending system for providing digital media contents to a user, comprising:
a) one or more centralized media server connected to a computer network, said centralized media server containing digital media contents or marketing information related to the digital media contents; and
b) a digital media vending machine comprising:
(i) an input device for allowing the user to select one or more desired digital media contents;
(ii) a digital media device interface for delivering the desired digital media contents to the user; and
(iii) a computer being communicably connected via broadband connection to the centralized media server for ordering the desired digital media contents and transferring the desired digital media contents from the centralized media server to the digital media device interface, said computer having:
(1) a high capacity media storage device used to cache one or more recently or frequently accessed digital media contents; and
(2) a software which performs an analysis of the desired digital media contents and suggest additional digital media contents that may be of interest to the user.

9. The digital media vending system of claim 8, wherein the digital media vending machine further comprises a monitor for displaying one or more video portions of the desired digital media contents.

10. The digital media vending system of claim 8, wherein the digital media vending machine further comprises an audio output device for allowing the user to listen to one or more audio portions of the desired digital media contents.

11. The digital media vending system of claim 8, wherein the digital media vending machine further comprises a financial exchange device for executing financial payment transactions.

12. The digital media vending system of claim 8, wherein the computer is adapted to display marketing information on the monitor that might be of interest to the user based on the desired digital media contents.

13. A digital media vending system for providing digital media contents to a user, comprising:
a) a centralized media server connected to a computer network, said centralized media server containing the digital media contents or marketing information related to the digital media contents; and
b) a digital media vending machine comprising:
(i) an input device for allowing the user to select one or more desired digital media contents;
(ii) a digital media device interface for delivering desired digital media contents to the user;
(iii) a computer being communicably connected to the centralized media server via broadband connection for ordering the desired digital media contents and transferring the desired digital media contents from the centralized media server to the digital media device interface, said computer being adapted to send back royalty information related to the desired digital media contents purchased by the user to the centralized media server, such that appropriate royalty may be paid to one or more owners of royalty rights to the desired digital media contents, said computer having:
(1) a high capacity media storage device used to cache one or more recently or frequently accessed digital media contents;
(2) a software which performs an analysis of the desired digital media contents and suggest additional digital media contents that may be of interest to the user;
(iv) a monitor for displaying video portions of the desired digital media contents;
(v) an audio device for outputting audio portions of the desired digital media contents; and
(vi) a financial exchange device for executing financial payment transactions.
